(19) United States
(12) Patent Application Publication
(10) Pub. No.: US 2011/0047377 A1
(43) Pub. Date: Feb. 24, 2011

(54) SECURE DIGITAL COMMUNICATIONS VIA BIOMETRIC KEY GENERATION

(75) Inventors: Josef Allen, Melbourne, FL (US); David Lyle, Titusville, FL (US); Mark Rahmes, Melbourne, FL (US); David Gierling, Malabar, FL (US); C.W. Sinjin Smith, Palm Bay, FL (US)

Correspondence Address: HARRIS CORPORATION;C/O FOX ROTHSCHILD, LLP, 997 Lenox Drive, Building 3, Lawrenceville, NJ, 08543-5231, US

(73) Assignee: Harris Corporation, Melbourne, FL (US)

(21) Appl. No.: 12/543,742

(22) Filed: Aug. 19, 2009

(51) Int. Cl. H04L 9/32; H04L 9/00

(52) U.S. Cl. 713/168; 380/44

(57) ABSTRACT

Systems and methods for secure communications in a communications network (100), including a server (102) and a client device (104a, 104b), are provided. A method includes transmitting a communications session request from the client device to the server (304), the session request including an in-situ biometric code associated with a biometric sample of a user. The method also includes separately comparing at the server and the client device the in-situ biometric code and an associated canonical biometric code based on comparison criterion (208, 310), the canonical biometric code representing a biometric reference for the user. The method also includes generating an encryption key at the server and at the client device based on the in-situ and canonical biometric codes (218, 314). The method further includes establishing an encrypted communications session between the server and the client device if the in-situ biometric code meets comparison criteria at the server and at client device (220, 316).

### FIELD OF THE INVENTION

The invention relates to secure digital communications, and more specifically to systems and methods for secure digital communications via biometric key generation.

### BACKGROUND

Encryption is a commonly used method of keeping information transmitted or accessible via an unsecure conduit confidential. In a conventional encryption processes, the original information (plain text) is typically transformed using a cryptographic algorithm and a cryptographic key into encrypted information (cipher text). In general, only knowledge of the algorithm and keys is necessary to recover the plain text from the cipher text. Accordingly, if a third party is able to gain access to part or all of the cipher text the plain text is still kept confidential since the third party would generally lack the key to decrypt the cipher text. Furthermore, attempting to computationally obtain the plain text from the cipher text without the key is generally impractical if an encryption algorithm with sufficient strength and complexity is selected.

To improve effectiveness against attacks by third parties, the encryption system must provide at least two features for keys. First, the encryption system should require keys with sufficient complexity so that a third party can not easily guess the key or that trying all possible keys is rendered impractical. Second, keys should be stored in a manner that prevents unauthorized third parties from gaining access to the keys.

In general, encryption systems are configured with one of two different types of key systems. The first type of key system is a symmetric key system, otherwise known as a single key system. In single key systems, the same key is used to both encrypt and decrypt the information. Advantages of single key systems include its simplicity and computational efficiency. An inherent weakness is that the key is shared among users, increasing the likelihood of a third party uncovering the key. The second types of key systems are asymmetric key systems. In asymmetric key systems, a pair of keys are used, one for encryption and one for decryption. In an asymmetric key system, a sender would obtain an intended recipient's public key. The public key would be used to encrypt the plain text into cipher text for the recipient. The recipient then uses a private key to decrypt and recover the plain text. In general, the private key cannot be determined from the public key, allowing the public keys to be freely distributed. A disadvantage of using asymmetric key systems is that the encryption process is generally computationally slower than in single key systems.

In some cases, a combination or hybrid approach is used. In such approaches, an asymmetric key system is used to establish a secure connection between a sender and a receiver. The secure connection is then used to transfer a symmetric key for performing symmetric key encryption tasks thereafter. In addition to encryption keys, some modern cryptographic systems utilize an Initialization Vector (IV) to ensure that a given plain text and cryptographic key will produce a unique cipher text.

### SUMMARY

Embodiments of the present invention describe systems and methods for secure digital communications via biometric symmetric key generation. In a first embodiment of the invention, the client device is a communications system. The client device includes a transceiver, a detector for acquiring at least one biometric sample associated with the user, and a processing element. The processing element is configured for generating an in-situ biometric code based at least on the biometric sample, comparing the in-situ biometric code and a canonical biometric code based on at least one comparison criterion, the canonical biometric code representing at least one biometric reference associated with the user, and configuring the transceiver to transmit the in-situ biometric code to a server and to establish at least one encrypted communications session based on at least encryption key if the comparison criterion is met.

In a second embodiment of the invention, a server in a communications system is provided. The server includes a transceiver configured for receiving one or more communications session requests from one or more client devices, each of the session requests including an in-situ biometric code associated with a biometric sample of a user at one of the client devices. The server also includes a processing element configured for processing each of the session requests. In the processing element, the processing includes comparing the in-situ biometric code and an associated canonical biometric code based on at least one comparison criterion, the associated canonical biometric code representing at least one biometric reference for the user associated with the in-situ biometric code. The processing also includes generating an encryption key based on the in-situ biometric code and the associated canonical biometric code and configuring the transceiver to establish at least one encrypted communications session based on at least the encryption key if the comparison criterion is met.

In a third embodiment of the invention, a method for establishing secure communications sessions in a communications network includes at least one server and at least one client device. The method includes the step of transmitting at least a first communications session request from the first client device to the server, including a first in-situ biometric code associated with a biometric sample of a first user at the first client device. The method also includes the step of separately comparing at the server and the first client device the first in-situ biometric code and an associated first canonical biometric code based on at least one comparison criterion, the first canonical biometric code representing at least one biometric reference for the first user. The method further includes the steps of separately generating a first encryption key at the server and at the first client device based on the first in-situ biometric code and the first canonical biometric code if the first in-situ biometric code meets a comparison criteria at the server and at the first client device, and establishing at least a first encrypted communications session between the server and the first client device based on the first encryption key.

### BRIEF DESCRIPTION OF THE DRAWINGS

FIG. 1 is a diagram of an exemplary communications network supporting communications using biometric keys in accordance with an embodiment of the invention.

FIG. 2 is a flow diagram of steps in an exemplary method performed at a client device for establishing a secure communications in accordance with an embodiment of the invention.

FIG. 3 is a flow diagram of steps in an exemplary method performed at a server for establishing secure communications with a client device in accordance with an embodiment of the invention.

FIG. 4 is a flow diagram of steps in an exemplary method performed at a server for establishing secure communications between two or client devices in accordance with an embodiment of the invention.

FIG. 5 is a schematic view of an exemplary computer system within which a set of instructions operate according to an embodiment of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Embodiments of the invention describe systems and methods for utilizing biometric signatures or codes to provide unique and secure symmetric keys. The term “biometric code”, as used herein, refers to any mathematical or computational representation of a biometric characteristic of a user. In particular, the symmetric key is generated by each party based on a combination of a biometric code generated from a current measurement or sample of a biometric characteristic of a user (in-situ biometric code), which can shared without encryption, and a biometric code generated from a reference measurement or sample of a biometric characteristic of a user (canonical biometric code) stored locally and securely by each party.

Such a configuration overcomes many of the limitations of existing encryption systems. First, since only a portion of the information needed for generating the symmetric key is transmitted over an unsecure network connection, the concern that the symmetric key will be intercepted is reduced or eliminated. That is, even if the in-situ biometric code is intercepted by a third party, the symmetric key cannot be discerned without knowledge of the canonical biometric code. Second, since the resulting encryption code is a symmetric code, the additional computation requirements for using asymmetric key pairs are reduced or eliminated. Additionally, the use of in-situ biometric codes permits a unique symmetric key to be created for each communications session, further improving the security of the session. In general, biometric characteristics and/or measurement accuracy can vary slightly over time. Accordingly, the algorithm for generating both the in-situ and canonical biometric codes can be configured to capture this variation. To compare a set of iris codes and authenticate a user, the Hamming Distance is computed using the equation shown in (1),

$$H D = \frac{‖ ( probeCode ⊗ galleryCode ) ⋂ probeMask ⋂ galleryMask ‖}{‖ probeMask ⋂ galleryMask ‖} \qquad ( 1 )$$

where {probeCode, probeMask} are derived from an unknown user's in-situ biometric code and {galleryCode, galleryMask} are generated from a database of one or more known user's canonical biometric code(s). In equation (1), ∩ and \textcircled{x} represent bit-wise AND and exclusive OR respectively. In the various embodiments of the invention, a valid match is considered for Hamming Distances less than 0.4 and not equal to zero. Such a configuration defeats attempts to compromise the system using a captured Canonical iris code. Once a user authenticates to their local canonical biometric code, they are permitted to attempt communication with another user, in the case of one-to-one communication, or a Certificate Authority (CA) in the case of a Public Key Infrastructure (PKI).

For example, an algorithm can be provided that generates biometric codes with large numbers of bits, such as on the order of 1000s of bits. As a result, not only will the in-situ and canonical biometric codes have a number of single-bit differences, but subsequent in-situ biometric codes generated will also generally result in a number of single bit differences as compared to both the canonical biometric code and previously generated in-situ biometric codes. The variation in the in-situ biometric code results in a variation in the symmetric key over time, the result of combining of the canonical and the varying in-situ biometric codes. Therefore, even if a third party intercepts the in-situ biometric code and gains access to the canonical biometric code and the key generating algorithm, the resulting key will generally not be valid during any subsequent communications sessions.

In the various embodiments of the invention, any type of biometric measurements or characteristics can be used to derive the in-situ and canonical biometric codes. For example, in some embodiments, the biometric characteristics can be physiological, i.e., measurements related to the shape or other physical characteristics of a user's body. Physiological biometric characteristics can include, but are not limited to fingerprint, face recognition, DNA, hand and palm geometry, iris recognition, retina recognition, and odor/scent. In other embodiments, the biometric characteristics can be behavioral, i.e. measurements related to characteristic behaviors of the user. Examples include, but are not limited to typing rhythm, gait, and voice. In still other embodiments, any combination of physiological and behavior characteristics can be used.

Although various types of biometric characteristics can be used with the various embodiments of the invention, certain types of biometric characteristics are more advantageous than others for encryption purposes. For example, iris scans are advantageous in that such scans are relatively consistent over time, are difficult to counterfeit, are relatively easy to collect, and can be used to generate sufficiently complex symmetric keys to defeat man in the middle attacks. However, the invention is not limited in this regard and other biometric characteristics could be used, although these may be susceptible to spoofing and counterfeiting attacks.

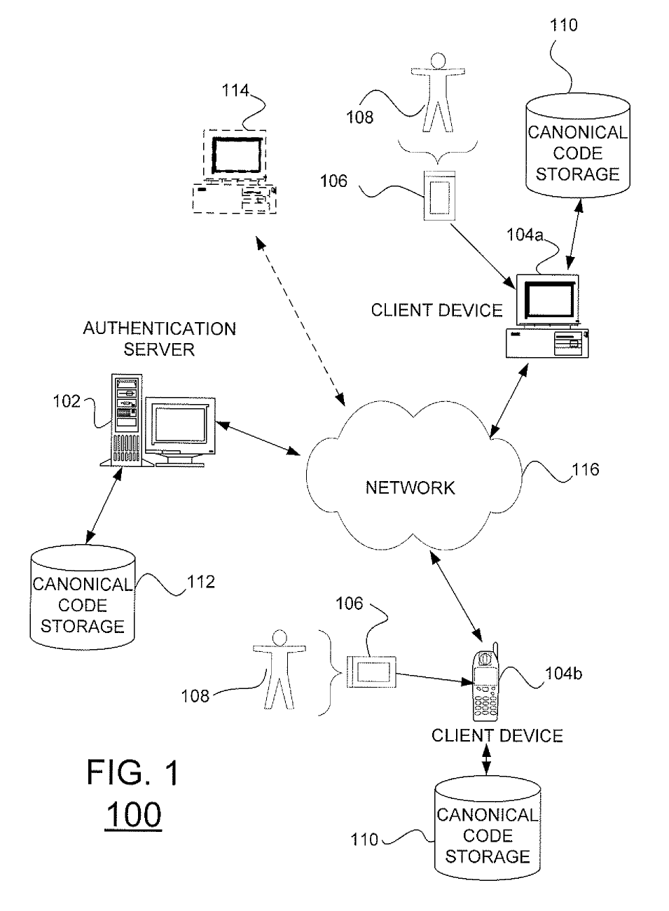

As described above, one aspect of the invention is to provide an encryption system in which only the in-situ biometric code needs to be transmitted over a network to establish a secure communications session. FIG. 1 depicts an exemplary embodiment of a system 100 supporting secure communications sessions using biometric codes according to an embodiment of the invention. The system 100 includes one or more authentication servers 102 accessible by one or more client devices 104a, 104b (collectively 104) that submit communications session requests to the authentication servers 102. Client devices 104 each include or are connected to a biometric detector 106 for measuring a biometric characteristic of a user 108 for generating an in-situ biometric code. Client devices 104 also each include or are connected to a local canonical biometric code storage element 110 for storing canonical biometric codes of authorized users. Authentication servers 102 also include or are connected to a local canonical biometric code storage element 112 for storing canonical biometric codes for authorized users.

In some embodiments, one or more engineer terminals 114 can also be used as an administrative interface to configure the authentication servers 102, the client devices 104, or any combination thereof. However, in other embodiments at least one of the client devices 104 can also be used as an administrative interface. In either case, the administrative interface can be used to configure operation of system 100. For example, via the administrative interface, an administrator can manage network and/or system properties of the authentication servers 102 and/or the client devices 104 and submit one or more criteria or instructions for use by the authentication servers 102 and/or the client devices 104 to establish secure communications sessions. The administrative interface can also be used to register users and load canonical biometric codes for registered users into canonical storage elements 110 and 112. Accordingly, the administrative interface may be implemented in a device having access to a detector for acquiring a reference measurement of a biometric characteristic of a user and a processing element for generating an associated canonical biometric code. However, the invention is not limited in this regard and the administrative interface can be used to configure any other property of the authentication servers 102 or the client devices 104.

As shown in FIG. 1, client devices 104 (and engineer terminal 114, if present) can be connected by way of wire line or wireless access paths through a network 116 to the authentication servers 102. In the various embodiments, one or more of the client devices 104 can be connected to the same or different components of the authentication server 102 over the network 116. Client devices 104 can also operate as single computing systems or as centralized or decentralized computing devices. For example, in the exemplary system 100, client devices 104 can comprise one or more local or remote computing systems deployed over network 106. Furthermore, although the authentication servers 102 and the client devices 104 are shown as discrete and remotely connected systems, it is also within the scope of the invention for the authentication servers 102 and the client devices 104 to operate as one or more single and/or locally coupled computing systems.

Additionally, it is within the scope of the invention for client devices 104 to represent any multimode communication device including, but not limited to, cell phone devices, desktop and portable computer devices, or personal digital assistant devices capable of supporting wire line and/or wireless communication technologies. In the case of wire line communications, client devices 104 can utilize xDSL, cable, or PSTN telephony interfaces for communicating over the network 116, which can include hybrid technologies that support circuit-switched packet-switched communications. The client devices 104 can also support accessory interfaces such as USB, Firewire, and other connectivity technologies.

Alternatively, or in combination, the client devices 104 can support any number of wireless communication protocols such as the family of 802.xx protocols defined by the Institute of Electrical and Electronics Engineers (IEEE). For instance, client device 104 can utilize long-range wireless access technologies such as, for example, cellular, software defined radio (SDR) and/or WiMAX to communicate with the network 116. Cellular access technologies can include, for example, CDMA-1X, UMTS/HSDPA, GSM/GPRS, TDMA/EDGE, EV/DO, and next generation technologies as they emerge. Additionally, client devices 104 can support short-range wireless technologies such as WiFi, Bluetooth, Zigbee, or cordless communications such as digital enhanced cordless telecommunications (DECT).

In the exemplary system 100, communications session requests can be provided to the authentication servers 102 from the client devices 104. However, the invention is not limited in this regard and the client devices 104 can also be configured to automatically generate and submit communications session requests to the authentication servers 102. For example, upon measurement of a user's biometric characteristic(s) at any of the client devices 104, a request for a secure communications session, which includes the in-situ biometric code for the user, can be automatically forwarded to the authentication server 102.

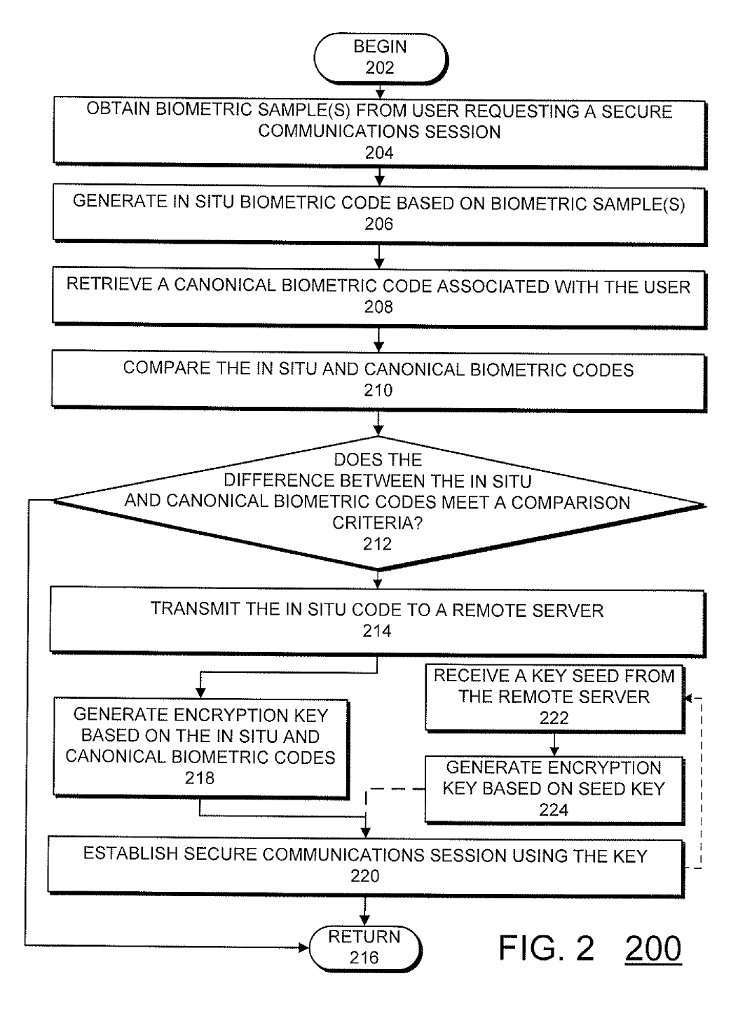

Based on the type of communications session request submitted to the authentication servers 102, the authentication servers 102 can establish a communications session with one or more of the client devices 104 over network 116 or generate seed keys for the client devices 104 and transmit them to the client devices 104, as described below with respect to FIGS. 2-4. Furthermore, although shown as single computing systems, the authentication servers 102, the client devices 104, and engineer terminal 114 (if present) can operate as centralized or decentralized computing devices or can be implemented as software components in a computing system.

FIG. 2 is a flow diagram of steps in an exemplary method 200 performed at a client device for establishing secure communications in accordance with an embodiment of the invention. Method 200 begins at block 202 and continues on to block 204. At block 204, the client device obtains or acquires one or more biometric samples from a user requesting a secure communications session. In the various embodiments of the invention, the user can request a secure communications session with a server, one or more client devices, or any combination thereof. As described above, the biometric samples can comprise measurements associated with physiological or behavioral characteristics of the user.

In some embodiments of the invention, block 204 can include a live tissue verification process. Such a configuration is useful to defeat attempts to present photographs of authorized user's eyes during the authentication phase. This is especially important in applications such as ours where the collection is self-supervised. For example, in the case of acquisition of biometric sample comprising images of an iris, the papillary reflex can be checked to verify that a live eye is being used. In general, even in uniform lighting, live human eyes exhibit changes in pupil size. Therefore, to verify that the biometric is being captured from a live iris, a series of images can be captured by the client device. Afterwards the client device can verify the occurrence of pupil size changes.

Once the biometric sample(s) are obtained at block 204, method 200 continues to block 206. At block 206, an in-situ biometric code is generated based on the biometric sample(s). For example, the biometric sample(s) can be provided as an input for an algorithm that generates a binary code. However, the invention is not limited in this regard and other types of in-situ biometric codes can also be generated.

After the in-situ biometric code is generated at block 206, a locally stored canonical biometric code associated with the user is retrieved at block 208. Method 200 can then proceed with authentication of the user at blocks 210 and 212. First, the canonical and in-situ biometric codes can be compared at block 210. The comparison at block 210 can be performed in several ways. For example, in some embodiments, the result of the comparison can be a value that represents the mathematical difference between the codes. In other embodiments, the result of the comparison at block 210 can be a value that represents a relative difference between the two codes. A value that represents the number of differences between the codes, a percentage difference between the codes, or any measure of the difference between the two codes could be used. For example, in one embodiment of the invention. a 256 byte iris code can be generated by encoding the visible portion of a human iris into a sequence of multi-scale quadrature 2-D Gabor wavelet coefficients. This technique has been shown to have a false accept probability of one in about 1031. Accordingly, even slight differences can generally be detected.

Second, after the comparison between the in-situ and canonical biometric codes is completed at block 210, the difference can be evaluated at block 212 to see if the difference meets comparison criteria. In the various embodiments of the invention, the comparison criteria can be selected such that normal variation in the in-situ biometric code still results in meeting the comparison criteria. Accordingly, if the comparison criteria define an upper threshold difference level and the difference obtained at block 210 is less than this level, the user is authenticated and method 200 proceeds to step 214. However, if the difference between the in-situ and canonical biometric codes is greater than the upper threshold difference value, the user is not authenticated. Therefore, method 200 can then continue to block 216 and resume previous processing. For example, method 200 can be restarted to retry authentication in the case of an error.

In some embodiments of the invention, additional comparison criteria can be provided to reduce the opportunity for counterfeiting or spoofing. In particular, the encryption system can be configured to expect at least some amount of variation over time in the in-situ biometric code associated with a user. For example, in one embodiment, a lower threshold difference level can be provided. Accordingly, if the in-situ canonical biometric codes are too similar or identical, the comparison criteria are not met. This prevents an authorized third party from gaining access to the system by providing the canonical biometric code to the client device as the in-situ canonical biometric code. In another example, the comparison criteria can be configured to prevent intercepted situ canonical data from being used for establishing secure communication sessions. In such embodiments, if the comparison results in a same difference between the in-situ and canonical biometric codes as in a previous communications session, access can also be denied to prevent unauthorized access. In some embodiments, these comparison criteria can be time-based to account for the possibility that a same in-situ biometric code might be generated at some later date.

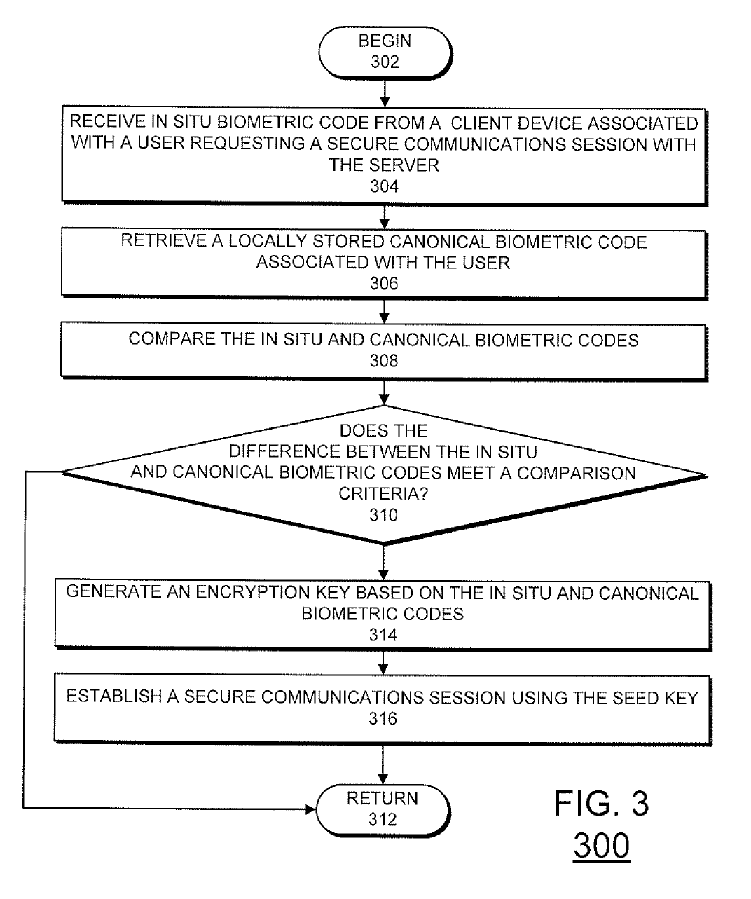

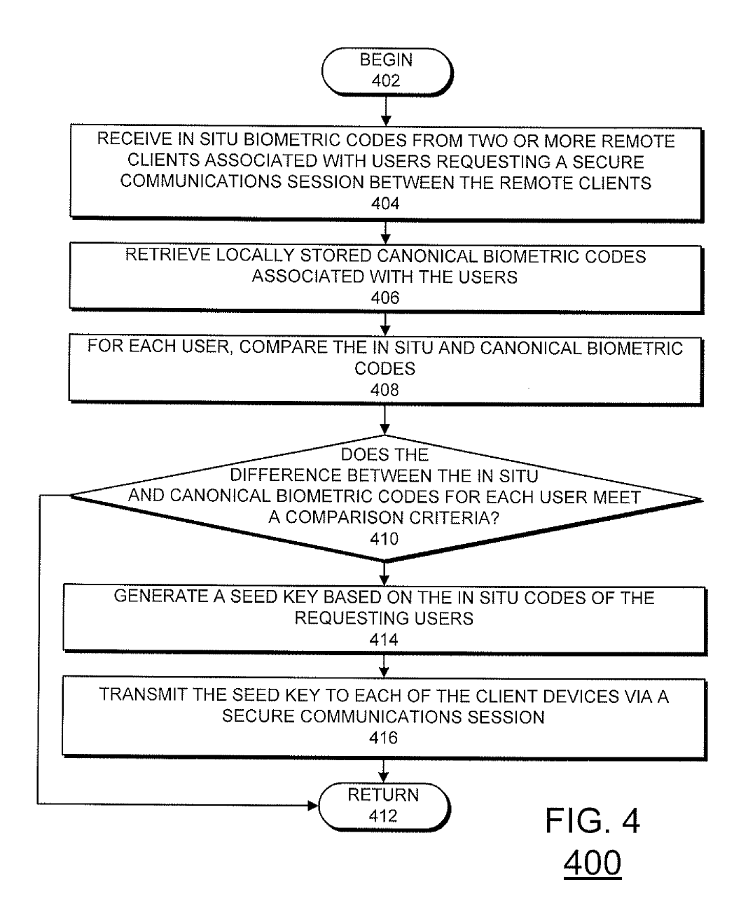

Once the user is authenticated via blocks 210 and 212, method 200 proceeds to block 214. At block 214, the in-situ biometric code is transmitted to a remote authentication server. The transmitted in-situ biometric code is then used by the remote server for authentication of the user and to configure remote devices for the communications session. The operation of the authentication server will be described below with respect to FIGS. 3 and 4

Subsequently or concurrently with block 214, an encryption key is generated at block 218 based on the in-situ and canonical biometric codes. In the various embodiments of the invention, the encryption key can be generated by combining the in-situ and canonical biometric codes using one or more mathematical operations. For example, in one embodiment, the encryption key can be generated by an addition of the codes, followed by a pre-defined permutation of the sum. In another example, the encryption key is generated based on a permutation of the canonical code, where the in-situ biometric code is utilized as an initialization vector. However, the invention is not limited in this regard and any other types or combinations of mathematical operations can be used to generate the encryption key.

In the various embodiments of the invention, the encryption key can also be formed or formatted to provide an encryption key for one or more encryption systems. In one embodiment, an encryption key for advanced encryption standard (AES) encryption can be generated. However, the invention is not limited in this regard, and the encryption key can be generated for other types of encryption systems. For example, data encryption standard (DES) or any variants thereof, and any other encryption system meeting the standards set for in FIPS PUB 140-2, including other deterministic and symmetric key encryption systems.

After the encryption key is generated at block 218, the client device can establish a secure communications session using the key at block 220. That is, the client device can be configured to support a communications session in which all communications to and from the client device are encrypted using the encryption key generated at block 218. For example, if the user request a communications session for retrieving data from a server, the data requests to the server will be encrypted with the key and the data retrieved from the server is decrypted using the same key. Similarly, if the communications session comprises an email or messaging session, all messages to and from the client device are decrypted and encrypted, respectfully, using the key. Although only a few exemplary communications sessions are described above, the invention is not limited in this regard. Rather, the various embodiments of the invention can be used to provide encryption for any type of communications session. Once the communications session is established at block 220, the method can continue to block 216 and resume previous processing, including repeating method 200.

In some embodiments, a client device can request a secure communications with another client device, as described above. In such embodiments, blocks 202-220 can be first performed to establish a secure communications session with an authentication server. Once the secure communications session with the server is established at block 220, the client device can receive at block 222 a seed key from the server. One exemplary embodiment of the generation of this seed key will be described below with respect to FIG. 4. Afterwards, method 200 continues to block 224 and generates an encryption key. The encryption key can be generated in several ways. For example, the client device can use and AES algorithm to generate an AES key from the seed key. However, the invention is not limited in this regard. Once the encryption key is generated at block 224, a communications session is established using the key. The method can then continue to block 216 and resume previous processing, including repeating method 200.

FIG. 3 is a flow diagram of steps in an exemplary method 300 performed at a server for establishing secure communications with a client device in accordance with an embodiment of the invention. Method 300 begins at block 302 and continues to block 304. At block 304, the server receives an in-situ biometric code from a user requesting a secure communications session with the server. This received in-situ biometric code can be, for example, the in-situ biometric code transmitted in a communications session request from a client device at block 214 in method 200.

After the in-situ biometric code is received at block 304, a locally stored canonical biometric code associated with the user is retrieved at block 306. Method 300 can then proceed with authentication of the user. This is performed at blocks 308 and 310. First, the canonical and in-situ biometric codes can be compared at block 308. Afterwards, the difference can be evaluated at block 310 to see if the difference meets comparison criteria. In the various embodiments of the invention, the server and the client device utilize the same comparison criteria. Accordingly, if the difference between the in-situ and canonical biometric codes does not meet the comparison criteria, the user is not authenticated on the server and access to a secure communications session with the server is denied. Method 300 can then continue to block 312 and resume previous processing, including repeating method 300.

If the user is authenticated at blocks 308 and 310, method 300 can continue to block 314. At block 314, an encryption key is generated at the server based on the in-situ and canonical biometric codes. In the various embodiments of the invention, since the encryption key is symmetric, the encryption key at the server is generated in the same way the encryption key is generated at the client device. After the encryption key is generated at block 314, the client device can establish a secure communications session using the key at block 316. That is, the server can be configured to support a communications session in which all communications to and from the server are encrypted using the encryption key. Once the communications session is established at block 316, the method can continue to block 312 and resume previous processing, including repeating method 300.

FIG. 4 is a flow diagram of steps in an exemplary method performed at a server for establishing secure communications between two or more client devices in accordance with an embodiment of the invention. Method 400 begins at block 402 and continues to block 404. At block 404, the server receives in-situ biometric codes from two or more client devices requesting a secure communications session. Each of these received in-situ biometric codes can be, for example, the in-situ biometric code transmitted by the client device at block 214 in method 200.

After the in-situ biometric codes are received at block 404, a locally stored canonical biometric code associated with each of the in-situ biometric codes are retrieved at block 406. Method 400 can then proceed with authentication of the users. This is performed at blocks 408 and 410. First, the canonical and in-situ biometric codes for each user (i.e., each client device) can be compared at block 408. That is, a difference between each in-situ biometric code and an associated canonical biometric code is determined. Afterwards, the differences can be evaluated at block 410 to see if each of the differences meets comparison criteria. In the various embodiments of the invention, the server and the client devices utilize the same comparison criteria. For example, the comparison criteria can be as previously described in relation to step 212. Accordingly, if the difference between the in-situ and canonical biometric codes for any of the users does not meet the comparison criteria, the users are not authenticated for a communications session. Method 400 can then continue to block 412 and resume previous processing, including repeating method 400.

If all the users requesting the secure communications session are all authenticated at blocks 408 and 410, method 400 can continue to block 414. At block 414, a seed key is generated for the client devices. That is, a key for the client devices to use to generate an encryption key. In some embodiments, to provide further security, the seed key can be based on the in-situ biometric codes received from each of the client devices. Accordingly, the seed key will vary over time, further reducing the likelihood of interception of communications by a third party. In the various embodiments of the invention, the seed key can be generated by combining the in-situ biometric codes using one or more mathematical operations. Furthermore, the seed key can be formatted for any type of encryption system. For example, in one embodiment, the seed key can comprise an AES seed key. However, the invention is not limited in this regard and the server can generate any type of seed key at block 414. Once the seed key is generated at block 414, the seed key can be transmitted to each of the client devices via a secure communications session at block 416. That is, the server can establish a secure communications session, as described in FIG. 3 with each of the client devices for purposes of transmitting the seed key. The method 400 can then resume previous processing at block 412, including repeating method 400.

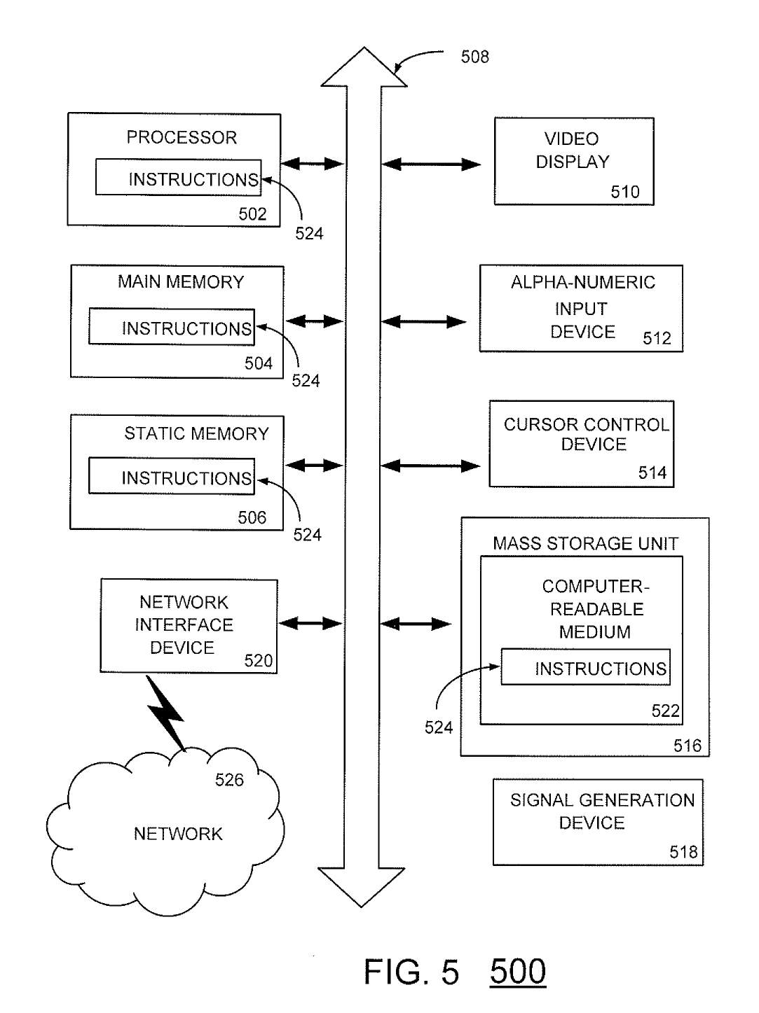

FIG. 5 is a schematic diagram of a computer system 500 for executing a set of instructions that, when executed, can cause the computer system to perform one or more of the methodologies and procedures described above. In some embodiments, the computer system 500 operates as a standalone device. In other embodiments, the computer system 500 can be connected (e.g., using a network) to other computing devices. In a networked deployment, the computer system 500 can operate in the capacity of a server or a client developer machine in server-client developer network environment, or as a peer machine in a peer-to-peer (or distributed) network environment.

The machine can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 500 can include a processor 502 (such as a central processing unit (CPU), a graphics processing unit (GPU, or both), a main memory 504 and a static memory 506, which communicate with each other via a bus 508. The computer system 500 can further include a display unit 510, such as a video display (e.g., a liquid crystal display or LCD), a flat panel, a solid state display, or a cathode ray tube (CRT)). The computer system 500 can include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 can include a computer-readable storage medium 522 on which is stored one or more sets of instructions 524 (e.g., software code) configured to implement one or more of the methodologies, procedures, or functions described herein. The instructions 524 can also reside, completely or at least partially, within the main memory 504, the static memory 506, and/or within the processor 502 during execution thereof by the computer system 500. The main memory 504 and the processor 502 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 524 or that receives and executes instructions 524 from a propagated signal so that a device connected to a network environment 526 can send or receive voice and/or video data, and that can communicate over the network 526 using the instructions 524. The instructions 524 can further be transmitted or received over a network 526 via the network interface device 520.

While the computer-readable storage medium 522 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A client device in a communications system, comprising:
a transceiver;
a detector for acquiring at least one biometric sample associated with the user; and
a processing element configured for:
generating an in-situ biometric code based at least on the biometric sample,
comparing the in-situ biometric code and a canonical biometric code based on at least one comparison criterion, the canonical biometric code representing at least one biometric reference associated with the user, and
if the comparison criterion is met, configuring the transceiver to transmit the in-situ biometric code to a server and establishing at least one encrypted communications session based on at least one of the in-situ encryption keys.

2. The client device of claim 1, wherein said at least one biometric sample comprises a plurality of biometric samples, and wherein said processing element is further configured for verifying that the acquired plurality of biometric samples are acquired from live tissue.

3. The client device of claim 1, wherein the processing element is configured to generate the encryption key based on at least the in-situ code.

4. The client device of claim 3, wherein encryption for the encrypted communications session comprises is based on advanced encryption standard (AES) encryption, and the encryption key comprises an AES encryption key.

5. The client device of claim 1, wherein the transceiver is further configured for receiving a seed key from the server and generating the encryption key based on the seed key.

6. The client device of claim 5, wherein the seed key is based a combination of the in-situ biometric code and at least one other in-situ biometric code associated with another user.

7. The client device of claim 1, wherein the biometric reference and the biometric sample are associated with at least one among physiological characteristics and behavioral characteristics of the user.

8. The client device of claim 1, wherein the detector comprises at least one among a fingerprint detector, an iris detector, a retina detector, and hand/palm detector.

9. The client device of claim 1, wherein the processing element is further configured during the comparing for determining at least one difference value for the in-situ and the canonical biometric codes, and wherein the comparison criterion is met if the difference value is less than a first threshold value.

10. The client device of claim 9, wherein the comparison criterion is met if the difference value is greater than a second threshold value less than the first threshold value.

11. A server in a communications system, comprising:
a transceiver configured for receiving one or more communications session requests from one or more client devices, each of the session requests comprising an in-situ biometric code associated with a biometric sample of a user at one of the client devices; and
a processing element configured for processing each of the session requests, the processing comprising:
comparing the in-situ biometric code and an associated canonical biometric code based on at least one comparison criterion, the associated canonical biometric code representing at least one biometric reference for the user associated with the in-situ biometric code, and
if the comparison criterion is met, generating an encryption key based on at least the in-situ code and configuring the transceiver to establish at least one encrypted communications session based on at least the encryption key.

12. The server of claim 11, wherein at least two of the session requests are associated with a same communications session, wherein the processing element is further configured for generating a seed key based on at least the in-situ biometric code associated with each the two of the session requests and for forwarding the seed key to the client devices associated with the two of the session requests.

13. The server of claim 11, wherein encryption for the encrypted communications session is based on advanced encryption standard (AES) encryption, and the encryption key comprises an AES key.

14. The server of claim 11, wherein the biometric reference and the biometric sample are associated with at least one among a plurality of physiological characteristics or behavioral characteristics of the user.

15. The server of claim 11, wherein the processing element is further configured for determining a comparative difference value representing a variation between the in-situ biometric code and the canonical biometric codes, and wherein the comparison criterion is met if the comparative difference value is less than a first threshold value.

16. The server of claim 15, wherein the comparison criterion is not met if the comparative difference value is less than a second threshold values less than the first threshold value.

17. A method for establishing secure communications sessions in a communications network comprising at least one server and at least a first client device, the method comprising:
transmitting at least a first communications session request from the first client device to the server, the first communication session request comprising a first in-situ biometric code associated with a biometric sample of a first user at the first client device;
separately comparing at the server and the first client device the first in-situ biometric code and an associated first canonical biometric code based on at least one comparison criterion, the first canonical biometric code representing at least one biometric reference for the first user;
if the first in-situ biometric code meets a comparison criteria at the server and at the first client device, separately generating a first encryption key at the server and at the first client device based on the first in-situ biometric code and the first canonical biometric code; and
establishing at least a first encrypted communications session between the server and the first client device based on the first encryption key.

18. The method of claim 17, further comprising:
transmitting at least a second communications session request from at least a second client device to the server, the second session request comprising a second in-situ biometric code associated with a biometric sample of a second user at the second client device;
repeating the comparing, generating, and establishing for the server and the second client device based on the second communications request;
generating a seed key based on the first and the second in-situ biometric codes; and
transmitting the seed key to the first and the second client devices.

19. The method of claim 18, wherein the transmitting further comprises generating the seed key to provide an advanced encryption standard (AES) seed key.

20. The method of claim 18, further comprising
establishing at least one encrypted communications session between the first and the second client devices based on an encryption key derived from the seed key.

21. The method of claim 17, wherein the biometric reference and the biometric sample are associated with at least one among physiological characteristics or behavioral characteristics of the first user.
